(19) United States
(12) Patent Application Publication
(10) Pub. No.: US 2019/0318577 A1
(43) Pub. Date: Oct. 17, 2019

(54) ELECTRONICALLY FACILITATED RANDOMIZED SPORTS POOL LOTTERY

(71) Applicant: Sean O'Hagan, Saskatoon (CA)

(72) Inventor: Sean O'Hagan, Saskatoon (CA)

(21) Appl. No.: 15/952,647

(22) Filed: Apr. 13, 2018

(51) Int. Cl. G07F 17/32

(52) U.S. Cl. CPC G07F 17/3258; G07F 17/3223; G07F 17/329; G07F 17/3251; G07F 17/3239

(57) ABSTRACT

An electronically facilitated randomized sports pool lottery based on at least one outcome of at least one sporting event. Tickets sold are randomly assigned at least one unique outcome of the at least one sporting event, and winning tickets are selected by matching the actual outcomes of the sporting events with the associated assigned event outcomes. The lottery format does not require the sale of tickets representing all possible outcomes of the event in order for a winner to be chosen and represents an enhancement over raffles requiring same. If a sold ticket does not correspond to at least one of the event outcomes, a winning ticket can be randomly selected from those sold or the prize attributable to the lottery can be pooled with subsequent proceeds of another lottery.

This invention is in the field of electronic systems for the vending of lotteries, and more specifically the vending, verification and redemption of a randomized sports pool lottery.

### BACKGROUND

Office pools have become a popular pastime for friends and co-workers to bet on various sporting activities. A paper-based sports pool for a single two team sporting match consists of creating a matrix of possible scores for each team, each representing a unique outcome for the game, and then effectively individuals choose one or more squares in the matrix on which they will be the pool participant. Although this type of sports pool is easiest to sell, not a lot of money can be raised as there are few available permutations—for example in a ten by ten matrix only 100 permutations exist. It is not intended for an audience of any size. An alternative to the matrix method of holding a sports pool is to print out all the possible scores and seal them in envelopes so the purchaser cannot know the scores he has purchased. Although this works, it is problematic selling all the tickets to a mass audience, and if all the tickets are not sold, then there may not be a winner.

The need to guarantee the outcome of a winner for a raffle has been a limitation in the prior art concepts of paper-based or electronically facilitated raffles related to sporting events—since the sports pool may not sell all the tickets or the final score may be outside the range of the pooled numbers so there would be no winner. Particularly where a raffle is being run as a pot-sharing fundraiser by a charity or the like if not all the raffle tickets are sold such that there is a possibility of no winner, the fundraising aspect of the raffle is at risk since with no winner no pot can be declared.

Unlike raffles, lotteries do not require winners. In a typical lottery, players buy tickets with a series of characters or numbers from authorized vendors at fixed prices. If there is no winner, the jackpot carries to a next lottery draw. To utilize the outcome of a sporting event for lottery purposes is possible. Rather than choosing the particular outcome of the sporting event, where skill is involved, a random assignment of final scores can be given on a ticket.

The limitations of the current sports pool raffles are evident. Unlike a lottery, a raffle requires a definite winner. A winner is not present if all the tickets are not sold and the final score is one of the unsold tickets, or the final score falls outside the range of what was thought as reasonable scores. The fund participation of the charity or operator is at risk. In addition, the considerable risk may be inherent in a traditional raffle, as a pre-determined prize has been fixed based on the sales of all tickets and not all the tickets may be sold, yet the winning ticket has been sold. Although unlikely, if only one ticket was sold and it was the winning ticket the charity has a lot of risks. The risk is magnified by paper solutions to the sports pool. The ability to reach a mass audience to sell all the raffle tickets necessary, for a large raffle with a large ticket volume, is difficult to physically achieve.

Because of the availability of electronic lottery systems and infrastructure, a system which would allow for the fulfilment and sales of an electronically facilitated sports pool lottery would provide additional revenue opportunities and uses for that existing infrastructure.

### SUMMARY OF THE INVENTION

The present invention provides a system and method for the conduct of an electronically facilitated randomized sports pool lottery based upon at least one outcome of a sporting event. The commercial utility of a sports pool lottery as a fundraising or profit mechanism is maximized while the risk to the sponsoring organization or presenter is minimized. As well, other prior art problems associated with paper-based systems and the like are minimized in the electronic execution of the lottery.

A sports pool lottery conducted under the present invention might be conducted regarding a single sporting event such as a single game or contest or the like, or in other circumstances the enhanced utility of the system and method of the present invention could also result in the ability to provide a wagering ability on a plurality of sporting events each with its own winning event outcomes. Many combinations of events and outcomes would lend themselves to providing the subject matter of background for the lottery method of the present invention.

The first step in the method of the present invention involves providing a lottery server. The lottery server hosts an outcome database which comprises a plurality of event outcome records. Each of the event outcome records corresponds to a unique event outcome of at least one sporting event within the scope of the lottery being administered. The lottery server also comprises a ticket database which, in a plurality of ticket records, holds the information related to lottery tickets sold in the lottery. Each ticket record includes a unique ticket identifier and is associated with at least one event outcome record from the outcome database. On the sale of the ticket, a ticket record will be created which contained the necessary ticket identifier information and details associating the ticket record with at least one potential event outcome record. Besides the ticket database on the outcome database, the lottery server but also comprises a network interface which would allow for communication with at least one lottery sales terminal, and a lottery administration software component capable of administering the ticket database on the outcome database, managing communications of the server with the at least one lottery sales terminal via the network interface, and otherwise generally administering the method outlined herein.

The method would also comprise providing at least one lottery sales terminal in communication with the lottery server via the network interface. The lottery sales terminal, as outlined in further detail below, could be a traditional lottery ticketing hardware and software system, or a website system through which the system could actually offer self-fulfillment or sale of lottery tickets to individual purchasers with no purchasing agent required to facilitate those transactions.

Lottery tickets are sold in the lottery during a defined sales window. For each lottery ticket sold, the steps of the method involved in the sale of that ticket comprise using the lottery sales terminal and the lottery server in conjunction with each other to firstly randomly select a desired number of available event outcome records from the outcome database, which are outcome records which are not yet associated with any other ticket record in respect of previously sold lottery tickets. A ticket record is created in respect of those selected available event outcome records in the ticket database. Upon the association of a particular event outcome record to a ticket record, that particular event outcome becomes a sold event outcome which is no longer available for association with another ticket record. Also, to maintain the lottery configuration of the contest administered in accordance with the method and to comply with certain legislative requirements, the purchaser of a ticket in accordance with the method of the present invention would not know the particulars of the associated event outcomes on which they were purchasing a ticket, beyond perhaps specifying the number of categories or event outcomes that they want to purchase in certain embodiments allowing for such customization, until after the ticket purchase transaction was completed. For example, if a purchaser purchased a lottery ticket which effectively resulted in the “purchasing” one event outcome corresponding to an event outcome record in the outcome database, corresponding to a single sporting event within the scope of the lottery, the purchaser would not know what the score or other detailed outcome was that they received with their purchase until after they completed their purchase. The randomization of the selection of the available outcome records on this basis is a novel aspect of the present invention over a conventional paper administered sports pool.

Following the closure of the defined sales window and/or the completion of the at least one sporting event pertaining to the lottery, winning tickets will then be selected by the lottery administration software component resident on the lottery server. Selection of the winning tickets effectively comprises selecting any event outcome records from the outcome database which correspond to the actual completion or outcomes of the at least one sporting event, being winning outcome records, and then identifying any ticket records and the ticket database corresponding to those selected winning outcome records, representing sold winning lottery tickets. The prizing in the lottery could then be awarded accordingly. It will be understood that in certain lotteries administered in accordance with the method of the present invention a single winner in a single prize might be configured, whereas in other embodiments or executions of the method there might be multiple outcomes with prizes attached—for example in certain embodiments where some of the event outcome records might include interim scores, player statistics and the like.

Upon selection of the winning outcome records, if there are no sold lottery tickets and corresponding ticket records of the ticket database corresponding to or assigned in respect of those winning outcome records, the lottery administration software component could be used to randomly select at least one winning ticket from the sold tickets in the lottery, or in other embodiments of the method, the prizing which would have been assigned to the various winning ticket outcomes for the lottery can be pooled to be awarded in a subsequent execution of the method—similar to the execution of many non-sports pool type lotteries present.

Given the lottery configuration of the system and method of the present invention it is not necessary that all potential event outcomes would be sold for the at least one sporting event and so it is possible that in the practice of the method of the present invention the winning event outcome for a particular sporting event would not have been sold—that might either mean that there was no winning ticket, or in certain embodiments of the system and method of the present invention it may be that in cases where no winning ticket was sold provision was made to randomly select a winner or the like.

The lottery administration software component operable upon the lottery server would administer the ticket database and the outcome database, and potentially manage communications via the network interface with the lottery sales terminals. The software can be of varying degrees of complexity and approach.

Various methodologies for the assignment of available event outcome records in ticket sale transactions can be contemplated. For example, the number of event outcome records associated with a particular ticket record in respect of the ticket sale could be one, or it could be more than one. As well, the number of event outcome records which would be associated with a particular ticket record for a ticket sale could be the same for every ticket sale or in certain cases might provide that the purchaser at the time of the purchase of their ticket might select a variable number of event outcome records which they wanted to purchase and that variable number of event outcome records would be the number of randomly selected and associated outcome records which would be associated with the ticket records stored within the ticket database.

The lottery sales terminal component of the system used for the actual fulfillment of sale transactions in accordance with the remainder of the method of the present invention might be a lottery sales terminal such as is already used in the sales of other types of lotteries. These lottery sale terminals typically comprise an operator interface, a network interface for communication with the lottery server, and terminal software by which an operator can sell tickets. The lottery sales terminal might also include a printer or other peripherals, by which ticket receipts and other documents could be printed or saved for distribution to purchasers or for other reasons within the fulfillment and sale of a particular ticket or the operation of the lottery sale of the present invention. Alternatively, or in addition to the use of a lottery sales terminal, a website system might be used as the lottery sales terminal such that a purchaser can directly purchase lottery tickets in the lottery administered with the remainder of the present invention. Where the lottery sales terminal comprised or included a website system, the Web server components of the website itself might be integrated with the lottery server or might comprise a separate Web server operatively connected to the lottery server for the administration of the method.

The number of sporting events regarding which a lottery in accordance with the present invention could be sold in respect of is also variable. In the simplest embodiments of the method of the present invention, a particular lottery and the related sports pool might relate to a single sporting event, or in other cases, a matrix of event outcome records might relate to a plurality of sporting events. Where the number of sporting events is more than one, at least one sporting event might be a discrete sporting event, or in certain cases, at least one sporting event of the plurality of events might be an interval scoring point within a discrete sporting event. The flexibility of this aspect of the method of the present invention will be understood by those skilled in the art of contest design. Besides discrete scoring outcomes or interval scoring outcomes of particular sporting events, and event outcome record matrix might also or additionally include combination outcomes of multiple teams in multiple games—for example, the development of a matrix that effectively replaced sports brackets or the like as our popular from the perspective of wagering etc.

We specifically assume that the operation and administration of a lottery in accordance with the method of the present invention where it was desired to assign more than one event outcome to individual ticket sales, might include within the dataset of event outcome records the subdivision thereof into a plurality of subgroups, whereby more than one event outcome record could be associated with the ticket sale, and at least one of those associated event outcome records would be selected from multiple subgroups. This would provide for comfort to the purchaser that they were gaining access to multiple different groupings of potential score combinations, for example, to diminish the likelihood of certain outcomes in the lottery. Combinations and options are endless.

The lottery prize in a lottery administered under the present invention could either be an advertised static amount of money or non-monetary prize or in another circumstance the prize offered could be a money amount based upon a percentage of ticket sales recorded on the ticketing database. These are both flexible options available in the scoping of the lottery such as a sports pool to be administered under the remainder of the method of the present invention and these options would presumably be found attractive from the perspective of not only offering the best possible sales combinations but also in terms of mitigating risk to the presenter.

Besides the method of the present invention, the invention also comprises a lottery server for the conduct of an electronically facilitated lottery in accordance with the method of the present invention. The server could be used with traditional lottery sales terminals as used in other contexts which would communicate via a network interface with the lottery server, or in other cases; the lottery server could interface to a lottery sales website system for the sale of tickets in accordance with the method outlined herein.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labelled with like numerals, and where:

FIG. 1 shows one embodiment of a matrix of possible event outcomes for an electronically facilitate randomized sports pool lottery in accordance with the present invention, in respect of the outcome of a single sporting match;

FIG. 2 shows an alternate embodiment of the matrix of FIG. 1 for use in a sports pool lottery in accordance with the present invention, with possible event outcomes subdivided into high and low subsets;

FIG. 3 shows an alternate embodiment of the matrix of FIG. 1 for use in a sports pool lottery in accordance with the present invention, with possible event outcomes subdivided into each team winning;

FIG. 4 shows an alternate embodiment of the matrix of FIG. 1 for use in a sports pool lottery in accordance with the present invention, with ties removed from possible event outcomes;

FIG. 5 shows another embodiment of outcomes matrices for use in a sports pool lottery in accordance with the present invention with possible scores subdivided into high/low subsets and each team winning;

FIG. 6 is a flowchart demonstrating the basic steps in one embodiment of the lottery sales method of the present invention, wherein winning tickets are randomly selected from the tickets sold if the winning event outcomes are not sold in association with a sold lottery ticket;

FIG. 7 is a flowchart demonstrating an alternate embodiment of the method of the present invention, wherein allocated prize funds are pooled for a subsequent lottery if a winning ticket is not sold;

FIG. 8 is a block diagram of one embodiment of a system architecture in accordance with the present invention, in which the lottery sales terminal comprises a plurality of lottery sales terminals;

FIG. 9 is a schematic drawing of one embodiment of a lottery server in accordance with the present invention;

FIG. 10 is a schematic drawing of the key components of one embodiment of a lottery sales terminal in accordance with the present invention;

FIG. 11 is a schematic diagram of one embodiment of an event outcomes database in accordance with the present invention;

FIG. 12 is a schematic diagram of one embodiment of a ticket database in accordance with the present invention;

FIG. 13 is a block diagram of an alternate embodiment of a system architecture in accordance with the present invention, in which the lottery sales terminal comprises a website system; and

FIG. 14 shows a demonstrative lottery ticket in accordance with the present invention, in which the associated event outcome records are printed and displayed.

### DETAILED DESCRIPTION OF ILLUSTRATED EMBODIMENTS

The invention is an improved method for holding a sports pool electronic lottery based on the final score of a single game or the final score on a series of games. Traditionally electronic lotteries have been for 50/50 lotteries or bearer ticket lotteries. With the advent of the internet, online and electronic lotteries allow mass participation from lottery ticket purchasers. Mass participation sports pools bring about their own risks.

The invention, a system and method for conducting an electronically facilitated randomized sports pool lottery regarding at least one sporting event by selling lottery tickets corresponding to potential outcomes of said at least one sporting event, allows for the electronic fulfilment and handling of a sports pool lottery which addresses shortcomings in prior art paper-based methods and will allow for wider adoption and commercial success as a fundraising or commercial activity.

The following definitions explain some of the terminology used in this technical field useful to understand the invention disclosure and the subject:
“Lottery”: A form of a contest in which several persons buy one or more tickets or opportunities to win a prize. There does not need to be a definite winner.
“Sports Pool”: a lottery based on the results of an individual game or sporting events. Ticket purchasers may not choose their scores or results, but must instead purchase a ticket with pre-set results stated on it. There is no skill involved in participation, and the winner is determined by chance when holding the ticket matching the outcome of the game or series.
“Lottery ticket”: A lottery ticket is the tangible record of a purchased playing opportunity in a lottery—for example, it often is a printed receipt. The ticket contains scores or results of sporting game or games, which are unknown to the purchaser until after the purchase of the ticket.
“Lottery Sales terminal”: is defined as a portable and wireless device, a remote hard-wired connected device or standalone cashier station used as a point of sale for lottery tickets—also called an RSU.

### Game Theory

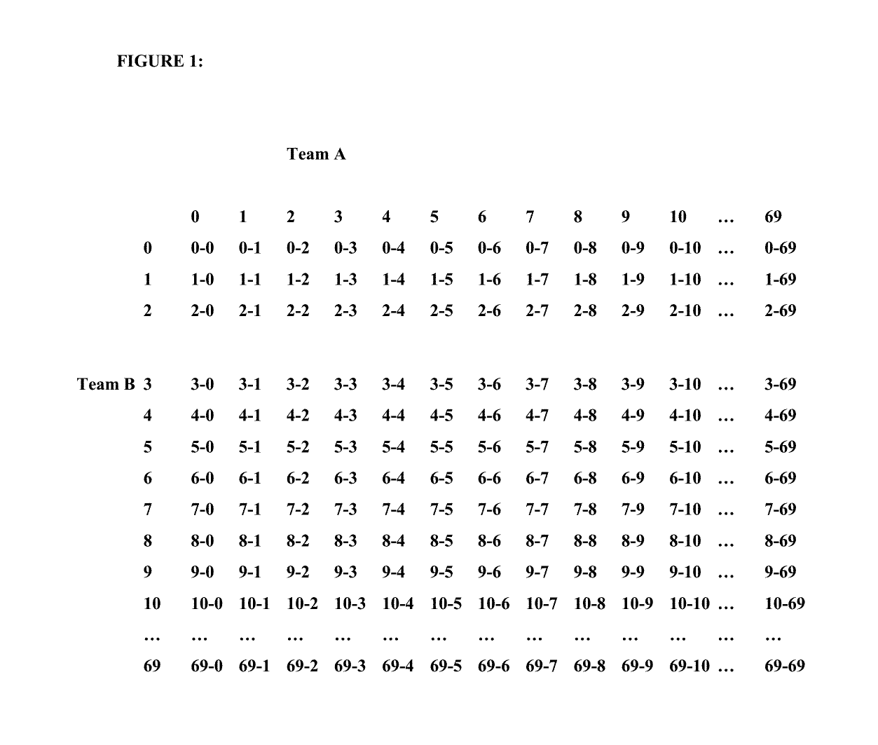

There are several iterations of sports pools, on one or more sporting events, which can be executed under the present invention. In basic paper-based sports pools, a matrix of possible outcomes is created. This is typically done by using a grid of equal size on both axes—one team is labelled at the top of the boxes and the other team going vertically down the left-hand side of the grid. This is, so potential players know which team will correspond to each number drawn. Bettors fill in each of the squares and money is collected for each square. The next step is to draw numbers for each row of squares—each square has two corresponding numbers. FIG. 1 shows a sample pool matrix which might have been created in a prior art paper-based approach for a single two team game going to a maximum score of nine points per team. Once the game is over, the operators of the pool simply would consult the board and see the corresponding square and give them their prize or winnings.

In FIG. 1, Paul has the square that corresponds to Team A scoring 6 points and Team B scoring 2 points. In football pools, just the last number of a team's score is used to determine the winning square. For example, Paul would also win the pool if Team B defeated Team A by a score of 12-6 or 42-26, etc. A reasonable range of scores must be determined for ticketing purposes for a sporting event such as a football game. For illustrative purposes, we will choose from 0-69 points. This means that either football team will score between 0 and 69 points. The number of possible individual team scores chosen should be an even number to allow an even number of possible two-team combinations. In the above example there are 70 possible individual team scores listed, and therefore 4900 possible combinations of scores range from both teams scoring 0 and both teams scoring 69. Team A could score 25 points while Team B scores 2 points or Team A scores 3 points, and Team B scores 55 points. Where Team A scored 25 points and Team B scored 2 points the winner holding the lottery ticket Team A 25 —Team B 2 would be the winner. The winning ticket is not known until the end of the game as it is dictated by the outcome of the match.

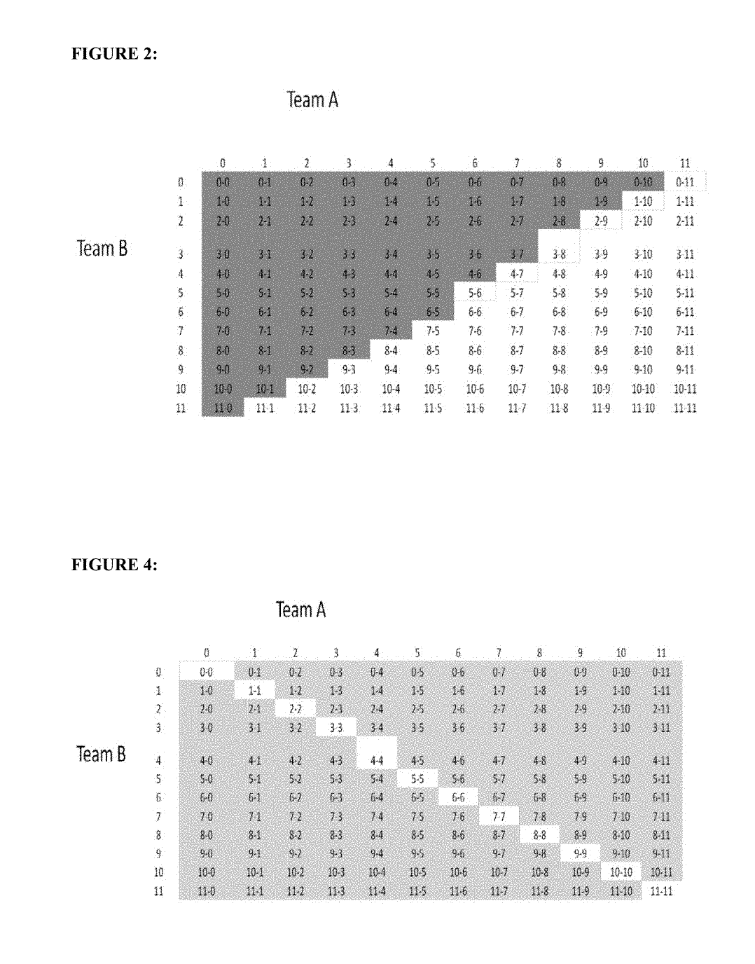

The reason to provide an even amount of possible combinations is that in this embodiment the sports pool lottery player receives two possible outcomes or scores on his lottery ticket. To ensure every possible combination can be sold if two combinations are given away with each ticket, there has to be an even amount of possible combinations. The total pool can be thought of as a matrix of 4900 squares, shown in FIG. 2. This is the database of event outcome records regarding the sporting event.

If only one possible score was on a ticket and the person received either 0-0 or 69-69, they are likely not happy with their ticket as the odds are very unlikely these will be the final scores. To alleviate this problem, two possible scores can be sold with the ticket. This helps to mitigate a player not being happy with an undesirable score if another score is more likely to have a chance at winning.

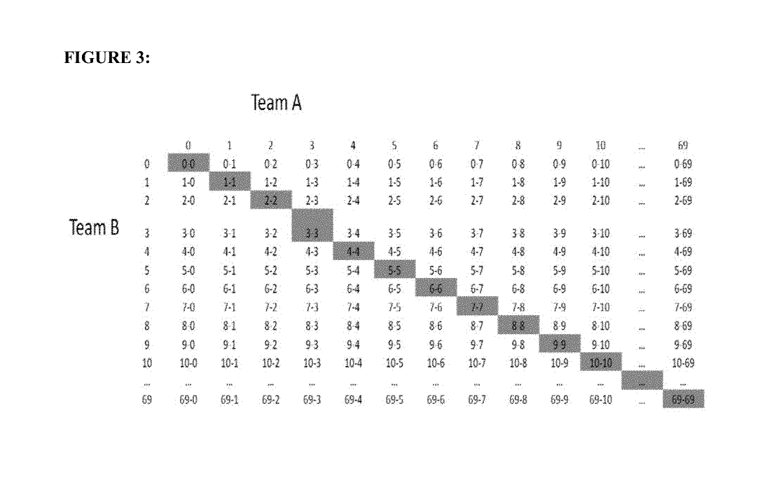

It is also possible to divide the database of event outcome records into a plurality of subsets of outcomes—for example in FIG. 3, the 4900 pool of outcomes will be divided in half with high numbers and low. A player will receive a set of numbers from both subsets; a low number and a high number. Many different combinations of gaming approaches such as this will be understood to be within the overall scope and method of the present invention and are all contemplated within the scope.

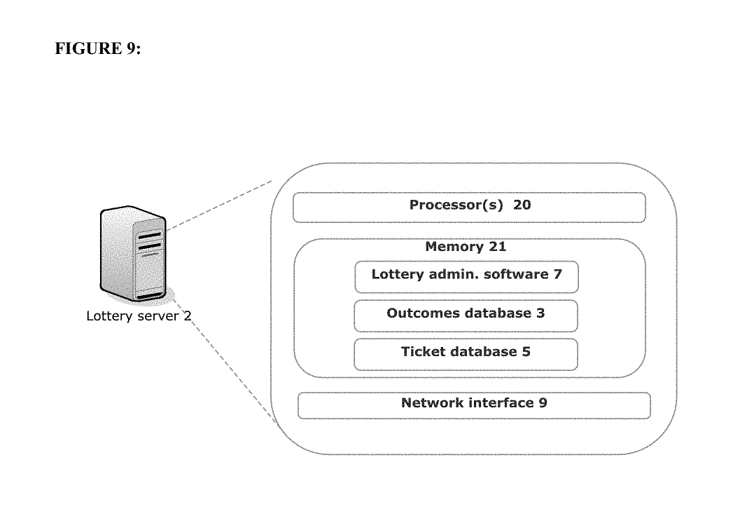

If the lottery was giving away 3 score combinations with a ticket, then a pool of 4900 does not work as three does not divide into 4900 evenly. The range of scores would have to be a multiple of three such as (0-68, or 0-71). Three subsets could be made; low, medium and high. To further mitigate the unhappiness of the player, in the low subset of 2450 possible scores, if Team A has a score higher than Team B, then for their second score from the high subset the player can receive a higher score for Team B than Team A, as shown in FIG. 4. If the lottery was awarding quarter time or half time score prizes, then ties must remain in the 4900 combination matrix. To understand within the scope of the claims of the remainder of the invention disclosure herein, if it was possible or desired to award quarter time or half time score prizes then each of these quarter-time or half-time intervals might be treated as separate sporting events from the perspective of selecting winners based upon the apportionment of event outcome records. The matrix is divided into 4 subsections with a random score from one subsection leading to random selection from the opposite subsection in FIG. 9. A low score Team A winning would be matched with a high score Team B winning.

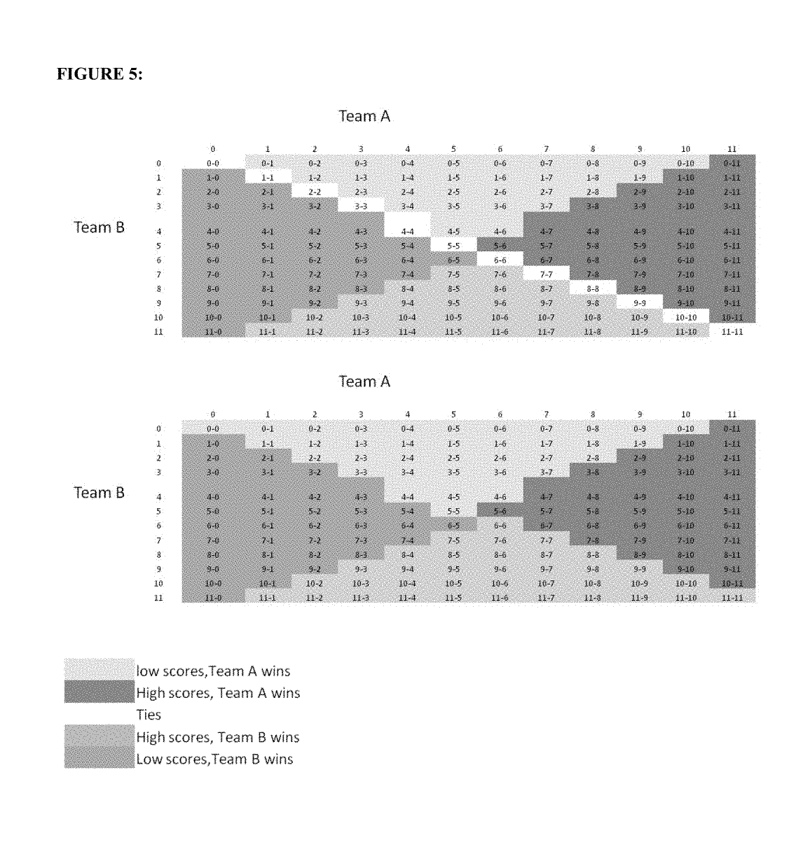

Ties could be handled as wild cards. The player will receive either team winning in the opposite subset. In many sports, a game cannot end in a tie. Perhaps since it is impossible to end in a tie, ties should not be part of the matrix. It is possible to remove all 70 tying scores, so every score wins shown, as shown in FIG. 5. In this embodiment, however, we will include ties as we will also have a half-time score prize.

A second embodiment of the invention could be purchasing electronic or online lottery tickets for the final score of a game that doesn't lend itself to mass lottery participation as there are not enough combinations of the final score as they are low scoring games. The final score of the final series of a sporting event could be utilized. For example, consider betting on the final NHL series. There are 30 teams in the NHL; the final series has 4 possible number of games and 21 possible scores if you consider the max score to be 6 goals.
Chances of getting the right two teams in winner/loser order: 1 in 870
Chances of getting the right # of games: 1 in 4
Chances of getting the final score right: 1 in 21
Overall chance of getting winning ticket 1 in 73,080

A $10.00 ticket would mean $730,800 in sales if you sold all the tickets. This would allow a jackpot of about $360,000. However, there is a risk if you do not sell all the tickets. Theoretically, you could only sell 1 ticket, and it could be the winner so the charity would be out $359,990 ($360,000-$10.00). To mitigate this risk, the charity could associate a plurality of event outcome records with each ticket sold, like above, and make the jackpot smaller. In this embodiment, three scores are given away with each ticket purchase. The jackpot can now be $100,000. Breakeven now becomes selling 10,000 tickets, rather than 36,000 tickets.

In certain cases it may be desirable to allow for the purchase of lottery tickets that included in the potential event outcomes interim scores at quarter-time, half-time etc. in a sporting event etc. In addition to interim scores, other potential event outcomes in respect of which lottery tickets could be sold by associating those outcomes with the ticket record in accordance with the method could include individual player statistics, or any other type of a statistic in the game for which it was possible to generate a range of potential values or outcomes. Where these different types of event outcomes were included in the matrix of event outcomes against which lottery tickets can be purchased, each of these groupings in term statistical outcomes or the like might be placed in the subcategories within the event outcome database such that for example the purchaser of a ticket in the randomized sports pool lottery of the present invention could purchase a ticket that associated outcomes from the different subcategories or subdivisions of event outcomes in the event outcome database—for example 1 ticket purchaser might only be interested in purchasing a ticket in relation to one or more final score event outcomes for a sporting event, and another ticket purchaser might be interested in purchasing a ticket that had one or more final score event outcomes associated therewith along with one or more event outcomes for half-time scores or the like. The flexibility of the method of the present invention would allow for purchasers within the same lottery pertaining to the same at least one sporting event to purchase tickets of either kind.

### Method Overview

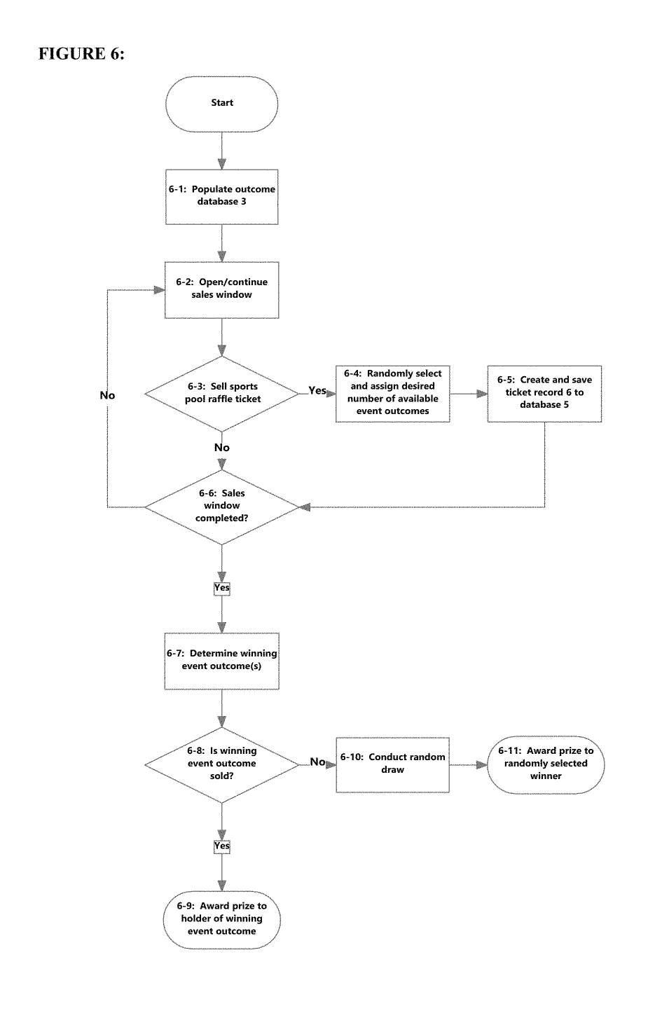

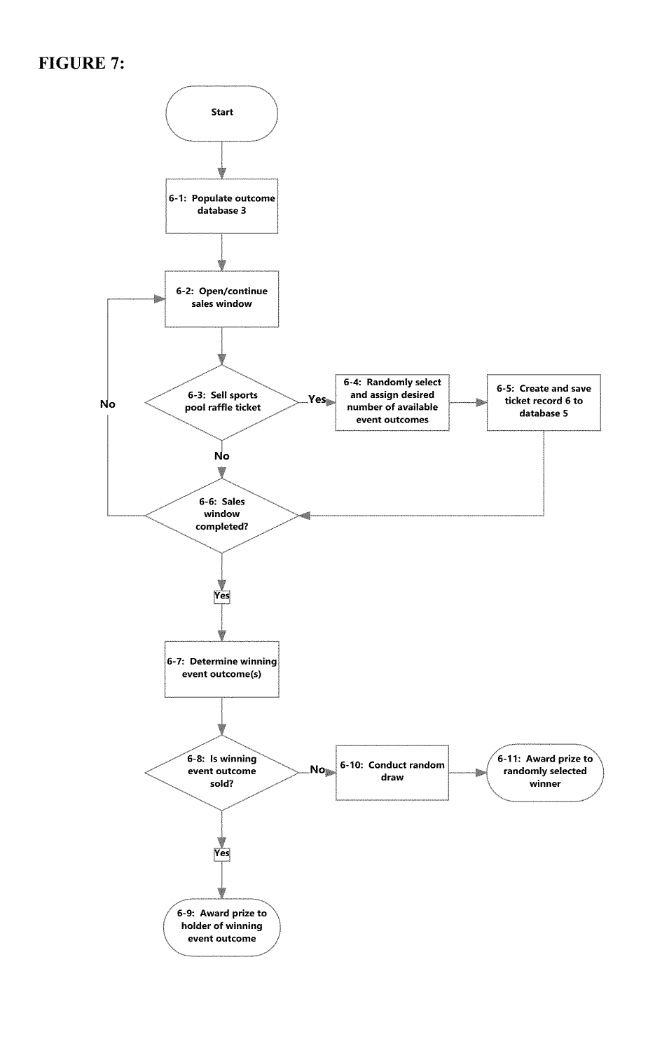

FIGS. 6 and 7 are flowcharts demonstrating the steps involved in two embodiments of the method of the present invention. Referring first to FIG. 6, using the server and the software of the present invention as outlined elsewhere herein, the event outcome database 3 would be populated with all of the necessary event outcome records 4 corresponding to the at least one sporting event in respect of which the lottery will be conducted—one event outcome record would need to be created for each event outcome record which it was desired to have available for Association or sample in association with ticket under the electronically facilitated randomized sports lottery system outlined herein. As outlined elsewhere herein, in a service provider type embodiment of the system of the present invention, the system and the related software and data structure could accommodate the administration of multiple lotteries and tickets as processes at the same time. Population of the event outcome database is shown at 6-1. The establishment of any other necessary parameters for the administration of the sports lottery in accordance would also be done at this step.

As outlined in the claims and the remainder of this document, tickets for sports pool lottery such as outlined herein are typically sold within a defined sales window—the defined sales window typically expire before the commencement of the related sporting emails. Following the completion of the population of the event database 3, the opening of the defined lottery sales window is shown at step 6-2. The defined lottery sales window is the time within which lottery tickets for the electronically facilitated randomized sports pool lottery under the present invention can be sold—the lottery sales window is shown as a loop in this figure, between steps 6-2 and 6-6. During the ticket sales window, lottery tickets will be sold to purchasers. Tickets will be sold to purchasers using the lottery sales terminal—which as outlined elsewhere herein might either be a lottery sales terminal or a lottery sales website. Ticket sales transactions would be initiated or completed within the ticket sales window.

During the open sales window if it is desired to sell a ticket in the randomized sports pool lottery of the present invention, shown at decision block 6-3, the steps of the sale of a lottery ticket in the sports pool of the present invention are shown on the “yes” leg of that decision block. The lottery tickets sold would be associated with at least one available event outcome from event outcome database 3. The lottery administration software component on the lottery server 2 would randomly select and assign the desired number of available event outcome records for from the event outcome database 3, and create ticket record 6 in the ticket database 5 in which a ticket identifier and the necessary database keys are the links to the associated and randomly selected available event outcome records would be stored.

The purchaser could specify a variable number of event outcome records regarding which they wish to purchase, or in some embodiments of the invention a predetermined number of available event outcome records 4 will be associated with each ticket sold. Both such approaches are understood to be within the scope of the present invention. The purchaser would not see the details of the event outcome records being associated with their ticket until after the purchase transaction was completed. Following the completion of the capture of the necessary particulars to generate a ticket sale, the ticket record would be created and saved within the ticket database 5, payment would be collected and potentially a receipt for the ticket which could include the ticket identifier or other information would be issued to the purchaser.

Following the saving of the ticket record to the database 3, the sales transaction would be completed, and the sales window listener could be continued, as shown at step 6-6. The loop in which sports pool lottery tickets under the remainder of the method would be available for sale would continue until the selected time for expiry of the lottery sales window should arise.

Following the completion of the sales window, shown at step 6-6 and the completion of the at least one sporting event, the winning event outcome or outcomes can be determined—shown at step 6-7. This would typically consist of matching the actual outcome of the sporting event or events with the event outcome database 3, to select the outcome records 4 which correspond to the actual outcomes of the sporting event or events—these would be the winning event outcomes. Following the selection of the winning event outcomes, it is necessary to determine whether the winning event outcome was actually sold in the sports pool lottery—this is shown at step 6-8. There could be more than one winning event outcome depending upon the types or categories of event outcomes for which event outcome records 4 were established in the event outcome database 3.

If a winning event outcome was sold and therefore is associated with a ticket record 6 in the ticket database 5, the prize regarding that event outcome can be awarded to the purchaser of that ticket. This is shown at step 6-9.

If a winning event outcome was not sold—that the winning event outcome remained unsold in the database 3 at the closure of the sales window, a random draw could be conducted, shown at step 6-10, to determine a winner. The random draw, shown at step 6-10 could be conducted conventionally by using printed paper counter foils or could be done using a random number generator or the like in the software on the lottery server 2. Following the conduct of the random draw at step 6-10, the prize regarding the unsold winning event outcome will be awarded to the randomly selected winner—which is shown in step 6-11.

The embodiment of the method shown in FIG. 7 is similar to that of FIG. 6, except instead of showing the conduct of a random draw to select a winner from sold ticket records in ticket database 5 if the winning event outcome or outcomes were not associated with sold tickets, that Figure shows the retention of the prizing from the lottery, to be pooled with subsequent lottery funds in another lottery to increase the size of the pot for another giveaway.

It will be understood there are many other different methods which could undertake this same overall approach and all such methods are many modifications to these methods that do not depart from the general scope and intention are contemplated within the scope of the present invention.

The prize for this of sports pool could be static such as $10,000 for the winner and $1,000 for a quarter-time or half-time score. The risk in this prize structure is if all the tickets are not sold, and there is a winner. Theoretically, only one ticket could sell, and it could be the winner however unlikely it is a possibility. If the charity/non-profit is not comfortable taking the risk of prize structure a percentage of collected sales could also be used. In this way, if all the tickets are not sold, then the winner receives a percentage only of what has been sold, and the charity is at no risk. This is easy to calculate with electronic or online sales.

### Illustrative Environment and System Architecture

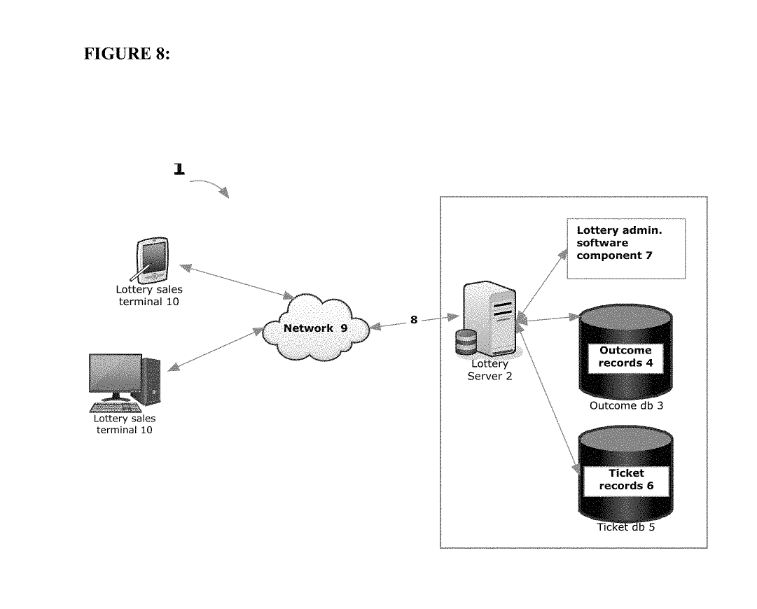

FIG. 8 shows an illustrative architecture of the overall system 1 of the present invention, in which ticket sales personnel can use lottery sales terminals 8, interacting with a lottery server 2, to sell and issue sports pool lottery tickets to purchasers under the remainder of the present invention. The system embodiment in this Figure uses a plurality of lottery sales terminals 8 for the lottery sales terminal. As outlined elsewhere below in another embodiment, the lottery sales terminal might comprise a website system through which tickets could be sold.

The lottery server 2 might include various software applications to manage aspects of the interaction between various components of the system 1, the lottery server 2 or the lottery sales terminals 8. Software applications on the lottery server 2 would include a lottery administration software component 7, responsible for the administration and handling of the method of the present invention. The lottery server 2 would host an event outcome database 3 and a ticket database 5, which was accessible to the software applications thereon and which would comprise a plurality of event outcome records 4 and ticket records 6.

The lottery sales terminals 8 would be connected to the lottery server 2 via a network 9. The network 9 could be any a communications network capable of communication between the lottery server 2 and the lottery sales terminals 8. It could be a wide area network, local area network or otherwise. The network 9 might be any combination of multiple different networks, such as cable networks, local area networks, personal area networks, wide area networks, the internet, wireless networks, ad hoc networks and mesh networks or the like. The architecture shown in FIG. 8 shows the lottery server 2 with two lottery sales terminals 8. Also shown is the network 9. These components are shown purely for demonstrative purposes and it will be understood that many different network architectures or system components and setups could be developed which would still accomplish the method outlined and all are contemplated within the scope of the present invention.

The lottery server 2 might house or otherwise connect to one or more data stores of various information required for operating the method of the present invention. Different data structures which will each accomplish the same overarching method of the present invention are possible.

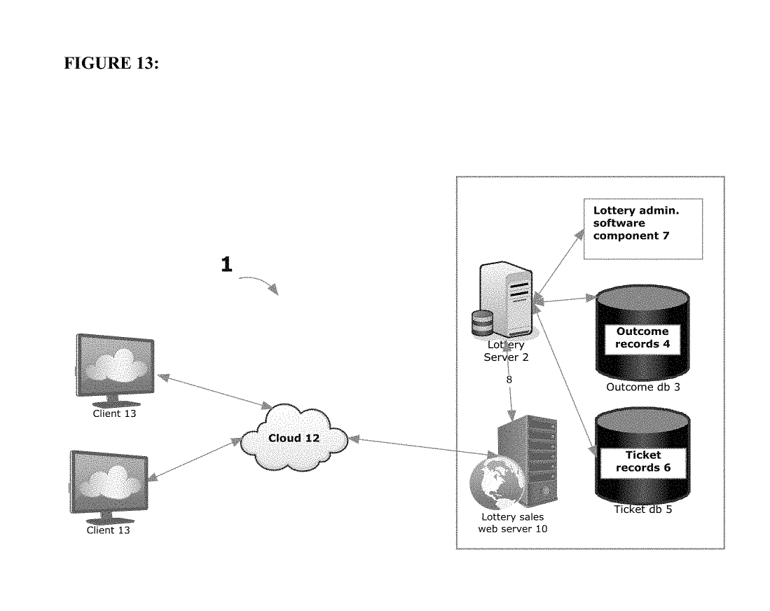

FIG. 13 shows an alternate embodiment of the system of the present invention, in which the lottery sales terminal comprises a website system rather than the plurality of lottery sales terminals 8 shown in FIG. 8. The lottery website system comprises a lottery sales Web server 10 operatively connected in such a way it can interact with the lottery server 2 and the ticket database 5 and with a plurality of client devices 15.

### Lottery Server

FIG. 9 outlines an illustrative embodiment of a lottery server 2 under the present invention. One or more lottery servers 2 might be implemented in the method of the present invention—a single server or a server farm approach. The server or servers 2 would each compromise one or more processors 20 and memory 21. The memory 21 might contain various software components or processor instructions for the method of the present invention or otherwise in operating the lottery server 2. Processor instructions corresponding to the lottery administration software component 7 are shown stored within the memory 21. Also shown stored in the memory 21 of this Figure are the event outcomes database 3 and the ticket database 5. The event outcome database 3 or the ticket database 5 could also be located on locally or remotely site storage which was accessible via a network connection to the lottery server 2.

Besides the general operating system instructions the lottery server 2 would compromise a lottery administration software component 7 which would be responsible for execution of the method of the present invention at the server. The lottery administration software component 7 might itself act as the interface between the remainder of the hardware and software of the lottery server 2 and the event outcome database 3 and the ticket database 5, or the lottery server 2 might include additional software interface to the databases with which the lottery administration software component 7 and its various subroutines could communicate. The lottery administration software component 7 would compromise subroutines to administer the ticket database 5, creating and modifying ticket database transactions and ticket records in interaction with the lottery sales terminals 8, and executing searches and reporting against the databases 3, 5 as required. The details of operating the lottery administration software component 7 are outlined herein.

Also shown in this Figure is the network interface 9. The network interface 9 would be the hardware and software components resident on or installed upon the lottery server 2 which would allow the lottery server 2 to communicate with the lottery sales terminals 8 and any other components in issuing tickets.

### Event Outcome Database

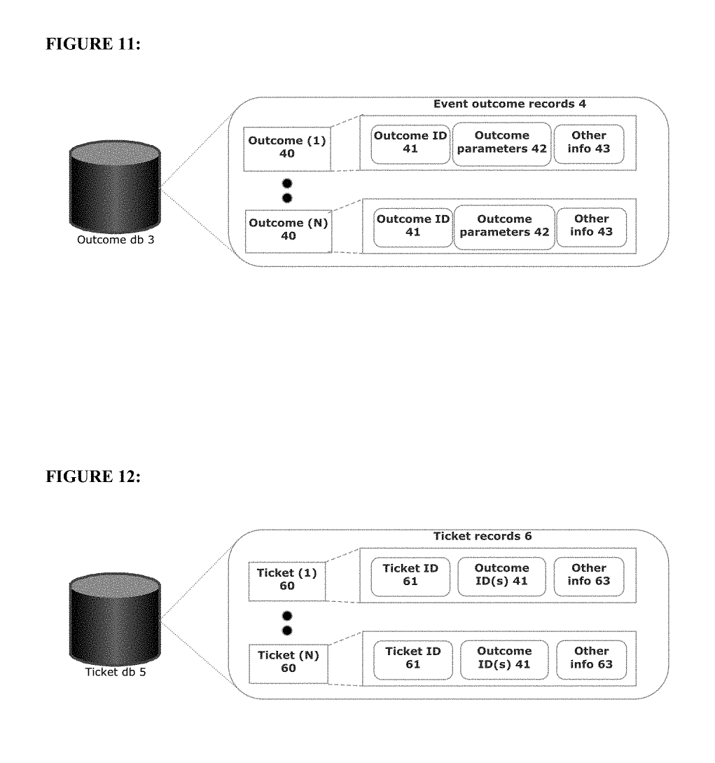

The lottery server 2 and the lottery administration software component 7 have access to an event outcome database 3 which stores a plurality of event outcome records 4 each of which pertain to individual potential event outcomes for the at least one sporting event which is the subject of the randomized sports pool lottery administered pursuant to the present invention. FIG. 11 is a schematic diagram of one embodiment of outcome database 3 in accordance with the present invention in which a plurality of event outcome records for each of which corresponds to a potential event outcome 40 is shown. In the embodiment shown, each event outcome record 4 includes a database key such as an outcome ID 41, as well as the parameters that the outcome 42—i.e. the parameters of the outcome would be the score or the other elements of the particular sport event outcome that would be used to determine whether a particular event outcome record 4 was a winning event outcome record, once the sporting events were completed. In addition to the necessary outcome parameters 42, other information might also be stored, shown at 43, in respect of the event outcome records 4.

As outlined above, in certain cases it may be desirable to allow for the purchase of lottery tickets that included in the potential event outcomes interim scores at quarter-time, half-time etc. in a sporting event etc. In addition to interim scores, other potential event outcomes in respect of which lottery tickets could be sold could include individual player statistics, or any other type of a statistic in the game for which it was possible to generate a range of potential values or outcomes. Where these different types of event outcomes were included in the matrix of event outcomes against which lottery tickets can be purchased, each of these groupings in term statistical outcomes or the like might be placed in subcategories within the event outcome database such that for example the purchaser of a ticket in the randomized sports pool lottery of the present invention could purchase a ticket that associated outcomes from the different subcategories or subdivisions of event outcomes in the event outcome database—for example one ticket purchaser might only be interested in purchasing a ticket in relation to one or more final score event outcomes for a sporting event, and another ticket purchaser might be interested in purchasing a ticket that had one or more final score event outcomes associated therewith along with one or more event outcomes for half-time scores or the like. The flexibility of the method of the present invention would allow for purchasers within the same lottery pertaining to the same at least one sporting event to purchase tickets of either kind. The structure of the event outcome records 4 in the event outcome database 3 could be used or adjusted to accommodate this type of a subdivided grouping of potential event outcomes and event outcome records 4 in respect of a sporting event. In addition to interim scores or statistics related to individual players etc., another type of event outcome in respect of which event outcome records 4 could be generated, where more than one sporting event was within the scope of the lottery, would be aggregated event outcomes of a series of games for example—aggregate scoring, win loss record of individual teams, aggregated players scoring across a series of events etc. I gain the necessary modifications to the event outcome records 4 within the event outcome database 3 to accommodate this type of an additional layer of flexibility in the wage rate allowed by the lottery outlined will be understood to those skilled in the concept of the invention and are all contemplated within the scope hereof.

The event outcome database 3 might be resident on the lottery server 2 within its storage, or might be resident on or administered remotely within another network attached storage or server from a database environment operatively connected for communication with the lottery server 2. The database 3 might also comprise multiple databases or files rather than a single database file or structure. The particular construction or data structure of the ticket database 3 might also depend on the infrastructure design of the remainder of the system of the present invention—again the aspects of the system, its structure and the ticket database 5 including those which are infrastructure dependent—will be understood to those skilled in the art of relational database and client-server system design and are all contemplated within the scope of the present invention.

### Ticket Database

FIG. 12 is a schematic drawing one potential embodiment of a ticket database 5 in accordance with the present invention, which comprises a plurality of ticket records six corresponding to tickets sold in the randomized sports pool lottery of the present invention. Sold ticket particulars would be stored regarding each ticket sold and would include a unique ticket identifier 61, which could be a serial number or some other unique identifier regarding the ticket to key the database. Besides a ticket identifier 61, a completed ticket record in the ticket database 5 would also include the information for the association of at least one event outcome record 4 from the event outcome database 3 therewith. Each event outcome record 4 of outcome database 3 could only be associated with an individual ticket record 6 and ticket sold and it would then be effectively locked out of resale. There might also be other information stored within the ticket record—for example purchase price, or other parameters and information—the other information 63 is also shown in the ticket record subset of the database 5 in this Figure.

Each ticket record 6 would represent a single lottery ticket sold in a lottery under the remainder of the present invention. As seen regarding the first ticket record 6 outlined in the Figure there are several key tokens in the ticket record 6. The first item within that ticket record 6 is a unique ticket identifier 61. The software components of the lottery server 2 and the lottery sales terminals 8 would generate and/or assign these unique serial keys to each lottery ticket during the sale so they could be stored in the ticket database. In certain cases, the ticket identifier 61 could be a field on the record 8 with multiple purposes and represented other information.

Ticket parameters 2 would also be stored in the ticket record 6 which would include other parameters or details of the lottery ticket sold—for example the price at which the ticket was sold, and explicitly, links to the associated event outcome records 4—shown as outcome ID 41 token in this Figure. Any necessary data tokens of fields which were necessary to calculate and/or operate such a lottery will be understood by those skilled in the art of game design and are contemplated within the scope of the present invention.

### Lottery Administration Software Component

The lottery administration software component 7 of the software resident on or accessible to the lottery server 2 would be key to performing the present method. We specifically assume the functions of the lottery administration software component 7 would include creation and administration of event outcome records 4 within the event outcome database 3 as well as ticket records 6 within the ticket database 5, interaction with the lottery sales terminals 8 or the lottery sales website to gather information from the purchaser or operators and from those devices 8 for the creation or updating of ticket records 6 within the database 3, and other query or reporting functions. Each of the software functions or modules could be freestanding software applications or subroutines within the memory or storage of the lottery server 2, or they could each be functions of a consolidated software program—both such approaches are contemplated within the scope of the present invention.

Overall the creation and administration of a record 4, 6 within the databases 3, 5 will be conducted by a database administration module. The database administration module would be responsible for the administration of records in various data subsets stored within the databases 3, 5.

The lottery administration software component 7 might also include a random number generator or the other necessary software instructions to enable the selection of winning tickets from ticket records in the ticket database where the random selection was required (the winning event outcome not being sold). If manual draw was the preferred approach regarding a particular implementation of the software and method of the present invention, the lottery server might be operatively connected to a counterfoil printer and the software server component 7 might include the additional query and reporting components to allow for the printing of counterfoils corresponding to active tickets and active ticket records within the database 5 for the conduct of the manual draw where required.

### Lottery Sales Terminal

Lottery server 2 would be in operative communication with at least one lottery sales terminal 8 to facilitate the sale of sports pool lottery tickets under the remainder of the method of the present invention. The lottery sales terminal 8 might be a pre-existing lottery sales terminal and related hardware and software, as used in other site-based lottery sales to sell bearer lotteries, with attendant software modifications. The lottery sales terminal also might be a website system used to facilitate the sale of sports pool lottery tickets under the remainder of the method—whereby either a vendor representative seeking to sell a sports pool lottery ticket, or even in a self-fulfillment approach that the customer themselves want to go to the website and simply purchase one or more lottery tickets under the remainder of the method, they can access the website using a client browser and effect the interaction with the remainder of the lottery sales website and the lottery server and the ticket database to finalize the purchase of tickets under the remainder of the method. It will also be understood that a third approach could be to provide a hybrid sales strategy and infrastructure, wherein the lottery server 2 was capable of communication with either or both of a plurality of lottery sales terminal hardware and a website so both types of sales could be accomplished under the remainder of the method for the sales of tickets in a sports pool lottery being administered otherwise generally under the present invention.

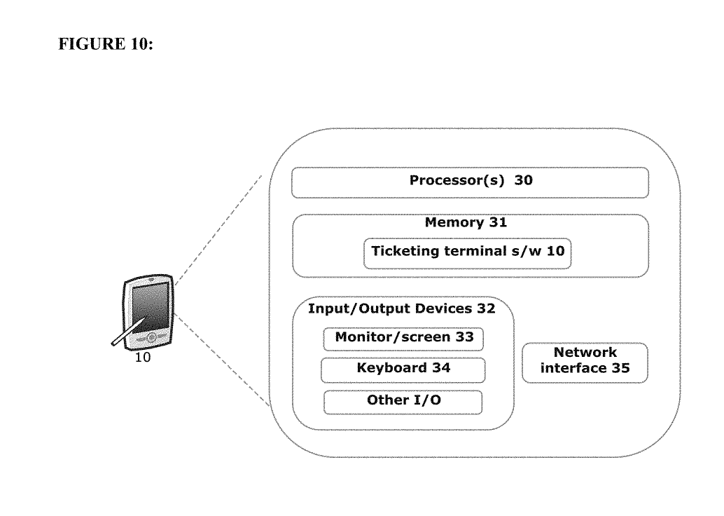

The system demonstrated in FIG. 8 shows a plurality of lottery sales terminals 8, and FIG. 10 is a schematic diagram showing a basic block configuration of one lottery sales terminal 8 under the present invention. Many types of hardware and software could be used in this an approach, and all will be considered within the scope of the present invention—even the configuration of a smartphone, tablet or another device as a lottery sales terminal 8, by incorporating appropriate software or components, is contemplated within the scope of the present invention. The lottery sales terminal 8 includes one or more processors 30 and a memory 31. Similar to computer memory on the lottery server 2, the memory on the lottery sales terminal 8 might include various types of processor instructions either for assistance in the execution of the method of the present invention or for other activities to be undertaken with the lottery sales terminal 8. The memory 31 would include a terminal software component 10 installed to communicate with the lottery server 2, and accomplishing the remainder of the method by providing the operator interface and enabling the operator of the lottery sales terminal 8 to interact with the purchaser and to issue lottery tickets under the remainder of this system and method of the present invention.

The lottery sales terminal 8 shown in this Figure also includes one or more input and output devices 32. This Figure shows the presence of a screen 33 as well as a keyboard or other data entry means 34 by which the operator of the device 8 could interact with and enter information for capture. In some implementations, the lottery sales terminal 8 might also include a clock, location sensor or the like. Also present in the lottery sales terminal 8 would be a network interface 35 by which the lottery sales terminal 8 could communicate with the lottery server 2 for the transmission of sold ticket particulars related to lottery ticket sales transactions completed on that lottery sales terminal to the lottery server 2, for creation of ticket records 6 within the ticket database 5 regarding tickets being sold by that lottery sales terminal 8.

The network interface 35 might use any network communication protocol depending upon this network infrastructure. In some implementations, the network interface 35 might be intended to send and receive data from the network wirelessly, and in other cases, a wired network connection might be used. Some deployments of network 9 under the remainder of the present invention could foreseeably include both hard wired and wireless lottery sales terminals 8. The method of the present invention could be practiced using pre-existing lottery sales terminals 8 by the provision of a modified software component 10 for installation and operation thereon. Both the retrofit of existing lottery sales terminal 8 hardware and custom-built or purpose-built new lottery sales terminal hardware 8 are contemplated within the scope.

### Lottery Sales Website

The second lottery sales terminal contemplated for accordance with the remainder of the method of the present invention, in place of or alongside the lottery sales terminals 8 outlined above, is the implementation of a lottery sales website system, whereby a website would be provided by which either a ticket seller or an individual purchaser wishing to facilitate or transact a sale of one or more lottery tickets under the remainder of the method of the present invention could do so via a website. Referring to FIG. 13, there is shown a lottery sales website system, which comprises a lottery sales Web server 10 operatively connected to the lottery server 2 to transact ticket sales transactions. Ticket purchasers or ticket sellers could access the ticketing Web server 10 via the client/server connection on the cloud 12 to the lottery sales Web server 10 from their client devices 15—the client device 15 could be any device with a web browser installed thereon which could communicate with the server 10.

The server 10 would contain the content, hardware, software and processor instructions to interact with both the client devices 15 and the components of the lottery server 2, to facilitate ticket sales transactions. The server 10 could be freestanding server hardware, or in some embodiments could actually constitute an additional software component installed on the same physical server as the lottery server 2. Both such approaches are contemplated within the scope of the present invention. Developing the software components for installation and execution on a Web server 10 which would allow for the transaction of ticket sales transactions under the remainder of the method of the present invention with the lottery sales server 10 comprising the lottery sales terminal outlined are all contemplated within the scope of the present invention.

Sold Tickets:

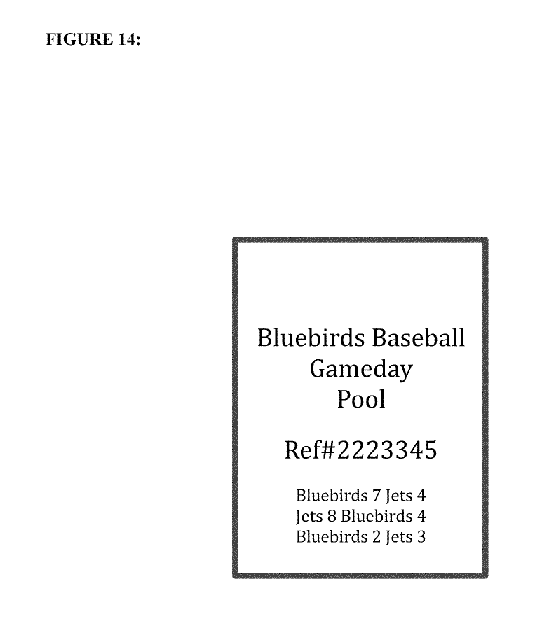

It is likely that a purchaser of a lottery ticket under the method of the present invention would be provided with a printed or electronically transmitted receipt for a ticket which outlined the details of the ticket purchased. FIG. 14 shows two examples of sample ticket stubs which might be provided to a purchaser of a ticket under the invention. In the ticket shown in FIG. 14, the purchaser has purchased three event outcome records regarding their ticket, and the event outcome records are listed.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced.

1. A method of conducting an electronically facilitated randomized sports pool lottery said method comprising:
a) providing a lottery server comprising:
i. an outcome database comprising a plurality of event outcome records, each event outcome record corresponding to a unique event outcome of at least one sporting event;
ii. a ticket database comprising a plurality of ticket records each corresponding to a lottery ticket sold in the lottery, each ticket record including a unique ticket identifier and associated with at least one event outcome record;
iii. a network interface for communication with at least one lottery sales terminal; and
iv. a lottery administration software component stored on an accessible memory device, for administering the ticket database and the outcome database and managing communications via the network interface;
b) providing at least one lottery sales terminal in communication with the lottery server, to transact the sale of lottery tickets to purchasers;
c) selling lottery tickets in the lottery during a defined sales window by, in respect of each sold ticket, using a lottery sales terminal in communication with the lottery server to:
i. randomly select the desired number of available event outcome records which are not yet associated with any ticket record for association with the sold ticket, being selected event outcome records;
ii. creating a ticket record in the ticket database storing the details of the selected event outcome records along with a unique ticket identifier;
iii. facilitate payment for the sold ticket by the purchaser; and
iv. furnish the details of the ticket record and associated event outcome records to the purchaser;
d) following the completion of the at least one sporting event, selecting at least one winning ticket from sold tickets by:
i. selecting any event outcome records from the outcome database which correspond to the outcome of the at least one sporting event, being winning outcome records;
ii. identifying any ticket records associated with the winning outcome records from the ticket database, being winning ticket records;
wherein the purchase of a ticket is not aware of the particulars of the associated event outcome records for their ticket until after the ticket purchase transaction is completed.

2. The method of claim 1 wherein on completion of the at least one sporting event if there are no winning outcome records at least one winning ticket record is randomly selected from the ticket database to be awarded the prize in the lottery.

3. The method of claim 1 wherein on completion of the at least one sporting event, if there are no winning outcome records, the prize in the lottery is retained to be pooled to be awarded the prize of another subsequent lottery in accordance with the method.

4. The method of claim 1 wherein the lottery sales terminal comprises an operator interface, a network interface for communication with the lottery server, and terminal software.

5. The method of claim 1 wherein the lottery sales terminal comprises a lottery sales website system in communication with the lottery server, by which a purchaser can purchase lottery tickets.

6. The method of claim 1 wherein the sale of a lottery ticket to a purchaser further comprises the transmission of a ticket receipt to an electronic device of the purchaser.

7. The method of claim 1 wherein the number of sporting events in respect of which a lottery is sold is one.

8. The method of claim 1 wherein the number of sporting events in respect of which a lottery is sold is more than one.

9. The method of claim 1 wherein at least one sporting event is a discrete sporting event.

10. The method of claim 1 wherein at least one unique event outcome is an interval scoring point within at least one sporting event.

11. The method of claim 1 wherein the event outcome records in the event outcome database in respect of at least one sporting event to be sold in the lottery are subdivided into categories, and a lottery ticket sold can be associated with event outcome records from multiple categories by the lottery administration software component if selected by the purchaser.

12. The method of claim 11 wherein the categories comprises comprise final event scores, interim event scores, or other verifiable player or event level interim or game-final metrics.

13. The method of claim 11 wherein the lottery includes event outcomes of more than one sporting event, and at least one category of event outcomes in respect of which he had outcome records are stored in the event outcome database are aggregated event outcomes across more than one of the sporting events.

14. The method of claim 1 wherein the number of event outcome records which is associated with a single ticket record is one.

15. The method of claim 1 wherein the number of event outcome records which is associated with a single ticket record is more than one.

16. The method of claim 1 wherein the number of event outcome records associated with each ticket record is the same.

17. The method of claim 1 wherein the number of event outcome records associated with each ticket record can be different.

18. The method of claim 17 wherein the purchaser can select the number of event outcome records for purchase in respect of their ticket at the time of sale, and based on that choose the correct number of available event outcomes is assigned to the ticket record for the ticket sold.

19. The method of claim 1 wherein the lottery prize is an advertised static amount or prize.

20. The method of claim 1 wherein the prize is a money amount based on a percentage of ticket sales recorded in the ticketing database.

21. A lottery server for the conduct of an electronically facilitated lottery in respect of at least one sporting event having at least one winning event outcome said server comprising:
a) an outcome database comprising a plurality of event outcome records, each event outcome record corresponding to a unique event outcome of said at least one sporting event;
b) a ticket database comprising a plurality of ticket records each corresponding to a lottery ticket sold in the lottery, each ticket record including a unique ticket identifier and associated with at least one event outcome record;
c) a network interface for communication with a lottery sales terminal; and
d) a lottery administration software component stored on an accessible memory device, for administering the ticket database and the outcome database and facilitating the method;
wherein said lottery server can be used in the administration of the lottery by:
a) selling lottery tickets in the lottery during a defined sales window by, in respect of each sold ticket, using a lottery sales terminal in communication with the lottery server to:
i. randomly select a desired number of available event outcome records which are not yet associated with any ticket record for association with the sold ticket, being selected event outcome records;
ii. creating a ticket record in the ticket database storing the details of the selected event outcome records along with a unique ticket identifier;
iii. facilitate payment for the sold ticket by the purchaser; and
iv. furnish the details of the ticket record and associated event outcome records to the purchaser;
b) following the completion of the at least one sporting event, selecting at least one winning ticket from sold tickets by:
i. selecting any event outcome records from the outcome database which correspond to the outcome of the at least one sporting event, being winning outcome records; and
ii. identifying any ticket records associated with the winning outcome records from the ticket database, being winning ticket records;
wherein the purchaser of a ticket is not aware of the particulars of the associated event outcome records for their ticket until after the ticket purchase transaction is completed.

22. The lottery server of claim 21 wherein on completion of the at least one sporting event if there are no winning outcome records at least one winning ticket record is randomly selected from the ticket database to be awarded the prize in the lottery.

23. The lottery server of claim 21 wherein on completion of the at least one sporting event, if there are no winning outcome records, the prize in the lottery is retained to be pooled to be awarded with the prize of another subsequent lottery in accordance with the method.

24. The lottery server of claim 21 wherein a lottery sales terminal comprises an operator interface, a network interface for communication with the lottery server and terminal software, by which an operator can sell tickets.

25. The lottery server of claim 21 wherein a lottery sales terminal comprises a lottery sales web site system, by which a purchaser can purchase lottery tickets.

26. The lottery server of claim 21 wherein a lottery sales terminal comprises a lottery sales web site system in communication with the lottery server, by which a purchaser can purchase lottery tickets.

27. The lottery server of claim 21 wherein at least one unique event outcome is an interval scoring point within at least one sporting event.

28. The lottery server of claim 21 wherein the event outcome records in the event outcome database in respect of at least one sporting event to be sold in the lottery are subdivided into categories, and a lottery ticket sold can be associated with event outcome records from multiple categories by the lottery administration software component if selected by the purchaser.

29. The lottery server of claim 28 wherein the categories comprises comprise final event scores, interim event scores, or other verifiable player or event level interim or game-final metrics.

30. The lottery server of claim 28 wherein the lottery includes event outcomes of more than one sporting event, and at least one category of event outcomes in respect of which event outcome records are stored in the event outcome database are aggregated event outcomes across more than one of the sporting events.

31. The lottery server of claim 21 wherein the number of event outcome records which is associated with a single ticket record is one.

32. The lottery server of claim 21 wherein the number of event outcome records which is associated with a single ticket record is more than one.

33. The lottery server of claim 21 wherein the number of event outcome records associated with each ticket record is the same.

34. The lottery server of claim 21 wherein the number of event outcome records associated with each ticket record can be different.

35. The lottery server of claim 34 wherein the purchaser can select the number of event outcome records for purchase in respect of their ticket at the time of sale, and based on that choice the correct number of available event outcomes is assigned to the ticket record for the ticket sold.
